(19) United States
(12) Patent Application Publication
(10) Pub. No.: US 2005/0129458 A1
(43) Pub. Date: Jun. 16, 2005

(54) Attachment system

(76) Inventor: Armin Hoffmann, Landsberg (DE)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 11/006,330

(22) Filed: Dec. 7, 2004

(30) Foreign Application Priority Data
Dec. 11, 2003 (DE) 103 57 844.7

(51) Int. Cl. B25G 3/00

(52) U.S. Cl. 403/256

(57) ABSTRACT

An attachment system for connecting a first component with a second component includes a screw element (12; 42) having at least regionwise, a first threaded section (15; 45), a bearing member (18; 48) for abutting one of the components and having a through-opening (19) through which the screw element (12; 42) is extendable; and a counter-screw element (27; 57; 77) defining an attachment axis (29; 59; 79) and having a second threaded section (28; 58; 78) cooperating with the first threaded section (15; 45), an engagement section (31; 61; 81), a bearing section (30; 60; 80) spaced from the engagement section (31; 61; 81) in a direction of the attachment axis (29; 59; 79), and a connection section (32; 62; 82) for connecting the bearing and engagement sections.

### BACKGROUND OF THE INVENTION

1. Field of Invention

The present invention relates to an attachment system for connecting a first component with a second component and including a screw element having torgue transmitting means and, at least regionwise, a first threaded section, a bearing member for abutting one of the components and having a through-opening through which the screw element is extendable, and counter-screw means defining an attachment axis and having a second threaded section cooperating with the first threaded section of the screw element. The present invention also relates to counter-screw means for an attachment system.

2. Description of the Prior Art

In construction of conduits and in particular of industrial pipelines, steel constructions are formed of steel constructional components which form a skeleton-like framework for the conduits. Conventionally, supports of a mounting system and having, e.g., a closed hollow cross-section and standard supports are used. The supports are connected with each other with connection or attachment elements to form a desired framework.

On supports, in addition to the connecting elements for other supports, connecting elements for conduits or attachments need to be arranged. For mounting of conduits in general and of pipelines, in particular, often C-shaped mounting rails are used on which pipe clamps or other attachment elements for conduits can be rapidly and cost-effectively secured with so-called rail nuts. Supports, in particular, supports of a mounting system often are provided with openings spaced from each other by a predetermined distance, with other components being secured to the supports with screw elements extendable through the openings. The screw elements usually includes screws, washers, and counter-screw means in form of e.g., check nuts. The washer is usually pushed over the threaded stem of the screw, and the threaded stem is pushed through the to-be-attached component and opening in the support. Then, a nut and another washer are mounted on the free end of the threaded stem. With actuation of the screw, while holding the nut the screw connection is tightened.

A drawback of the above-described connection consists in that with a closed hollow profile or with a support accessible only from one side, the conventional screw elements cannot be used because retaining of the check nut is not possible.

For attachment of components to supports having a closed hollow profile or accessible only from one side, so-called insert or press-fit nuts are used that are inserted into the support openings and are press-fitted there. The press-fit nut have an inner thread which is engaged by the outer thread of a screw for securing a component to the support.

The drawback of the use of a press-fit nut consists in that the openings in the supports should be adapted to the outer dimensions of the press-fit nut to prevent rotation of the nut in the support. The insertion and press-fitting of the nut in a support lead to additional expenses associated with the assembly of a system which under certain side constraints such as, e.g., in height, and under unfavorable conditions at the assembly site, are not insignificant. During disassembly or a change of the direction of a conduit or of the support structure, the press-fit nuts remain in the support which often is undesirable for constructive and/or aesthetic reasons.

Accordingly, an object of the present invention is a simple attachment system for securing a first component to a second component and which can be easily mounted and is flexible in its use.

Another object of the present invention is an attachment system that can be economically produced.

A further object of the invention is simple and flexible in use, counter-screw means that can be economically produced.

### SUMMARY OF THE INVENTION

These and other objects of the present invention, which will become apparent hereinafter, are achieved by providing counter-screw means having an engagement section, a bearing section spaced from the engagement section in a direction of the attachment axis and a connection section for connecting the bearing section with the engagement section.

The engagement section of the counter-screw means in introduced into the opening of the first component and the opening of the second component that has a closed hollow profile. The dimensions of the bearing section are so selected so it would abut the to-be-secured component but cannot fall through both openings into the second component with a closed hollow profile. The inventive attachment system is usable not only with a support provided with openings and accessible only from one side, but also with a support of any other type and shape, as long as this support is provided with openings through which the engagement member of the counter-screw means can be introduced. The distance between the engagement and bearing sections corresponds to a distance necessary for securing the first component to the second component. Advantageously, this distance corresponds at least to a sum of a wall thickness of a first component and a wall thickness of a second component.

The first component has, at least in its elementary section that would lie on the second component, a through-opening which is formed, advantageously, as an elongate opening. The first component, which has several elementary sections, has through-openings in each of the elementary sections, which provides flexibility in the use of the second component. For mounting of the inventive attachment system, the first component is so aligned relative to the second component that the through-opening of the first component is arranged above an opening of the second component. The engagement section of the counters-screw means is introduced through both openings. Finally, the bearing member of the attachment system is properly arranged, and a screw element is inserted through the through-opening of the bearing member, and the first threaded section engages the second threaded section. The assembled attachment system is pushed sidewise until the connection section of the counter-screw means engages an edge of the opening in the second component. With suitable means, e.g., a wrench, which engages a hexagon screw head of the screw element that serves as torque transmitting means, the screw element is actuated, tightening the attachment system. Upon tightening, the counter-screw means is pulled in direction toward the bearing section which is supported on the first component, and the first component is secured to the second component, i.e., fixed thereon.

As a screw element, preferably, a screw with an outer thread that functions as a first threaded section, and with a screw head an outer diameter of which is greater than the inner diameter of the through-opening in the bearing member, is used. On the screw head, there can be provided a band that increases the outer diameter of the head or a corresponding washer can be arranged.

The bearing section of the counter-screw means is formed preferably as a nut, with the second threaded section being formed by the nut inner thread. Alternatively, there can be provided, on the bearing section of the counter-screw means, a section with an outer thread serving as a second threaded section that would cooperate with a sleeve-shaped screw element having, at least regionwise, an inner thread functioning as a first threaded section.

The attachment system according to the present invention can be made available either as separate elements or in an assembled state. The screw element, the bearing member, and/or the counter-screw means are formed, preferably of metal, advantageously of a stainless steel. Dependent on an acting load and outside conditions, the screw element, the bearing member, and/or the counter-screw means can be formed of a plastic material.

Preferably, the distance between the connection section and the attachment axis amounts maximum to a triple of the diameter of the second threaded section. With such dimensions, the stresses that occur in the counter-screw means upon tightening of the attachment system, can be dealt with a small as possible thickness of the material used for producing the counter-screw means, and the counter-screw means can be cost-effectively manufactured. Advantageously, the distance between the connection section and the attachment axis is smaller than a diameter of the second threaded section, which results in optimization of the thickness of the counter-screw means and a most economical production of the counter-screw means. Generally, the entire outer dimensions of the counter-screw means can be small, which permits to easily handle the attachment system even in a narrow space.

Advantageously, the distance between the connection section and the attachment axis is so selected that the sum of the outer diameter of the screw element and the thickness of the connection section of the counter-screw means corresponds to the size of an opening in the second component. With such dimensions, the connection section of the counter-screw means abuts the opening edge, and the bending load acting between the engagement section and the connection section of the counter-screw means is minimal. This also permits to optimize the thickness of the counter-screw means and insures its economical manufacturing.

Preferably, at least one of the surfaces of the engagement section extend substantially parallel one of the surfaces of the bearing member. Such counter-screw means can be simply introduced into the opening of the first and second components and be displaced therethrough. Alternatively or as a variant, a surface of the engagement section that contacts the support can form with a surface of the bearing member that contact the first component, an acute angle so that upon tightening of the attachment system, a certain spring action is provided between the counter-screw means and the second component. The presence of such spring action is particularly favorable when the attachment system is subjected to dynamic loads.

Advantageously, a guide sleeve is provided on the bearing section for the screw element. This design of the counter-screw means is particular advantageous at a large distance between the counter-screw means and the bearing member, as the guide sleeve guides the screw element upon its displacement, which facilitates assembly of the attachment system. Advantageously, the second threaded section is formed in the guide sleeve. By increasing the thread length of the second threaded section, the attachment system can withstand large loads.

Advantageously, the bearing member has a flat, e.g., rectangular shape with opposite flat sides. The outer dimensions of the bearing member are so selected that the bearing member abuts the first component on both opposite sides of the through-opening formed in the first component or abuts the entire elementary section of the first component.

Advantageously, the bearing member is provided on its opposite sides with webs. Both webs are provided on the same flat surface of the bearing member so that the bearing member is shaped as a bridge. The height of the webs is so selected that the free space between the upper edges of the bearing section of the counter-screw means and the lower edges of the bearing member is greater or at least equal to the tightening path. This is to insure that the counter-screw means is capable of being sufficiently pulled back upon insertion of the screw element, which is necessary for an adequate attachment of the first component to the second component.

Advantageously, at least one projection is provided on each web of the bearing member. The width of the at least one projection is advantageously smaller than the width of the through-opening in the first component. Thereby, the at least one projection can penetrate in this through-opening and, upon actuation of the screw element, it serves as rotation-preventing means for the bearing member. The through-opening in the first component is generally formed as an elongate opening, and the projections form a guide for displacement of the bearing member along the longitudinal axis of the elongate opening.

Advantageously, the webs of the bearing member are provided with facing each other, locking noses for retaining, e.g., the counter-screw means on the bearing member when both are jointly displaced. The locking noses prevent loss of the counter-screw means and facilitate assembly of the attachment system at least during the joint displacement of the bearing member and the counter-screw means.

The counter-screw means according to the present invention, in particular, for an attachment system for connecting a first component and a second component, as described above, includes an engagement section, a bearing section spaced from the engagement section in a direction of the attachment axis, and a connection section for connecting the bearing section with the engagement section. The counter-screw means according to the present invention provides an accessible from outside, second threaded section into which the screw element for connecting the first and second components is screwed in. In addition, the inventive counter-screw means provides an attachment point on the second component.

The engagement section of the counter-screw means can be inserted in the through-opening of the first component and/or the opening of the second component, e.g., an opening of a support of a mounting system and having a closed hollow cross-section. The bearing section has such dimensions that it abuts the first and/or the second component and that the counter-screw means cannot fall into the second component through the opening therein. The inventive counter-screw means can be used, in addition to a support provided with openings and accessible only from one side, with any type of a support as long as the support is provided with openings through which the engagement section can be inserted. The distance between the engagement section and the bearing section corresponds, in order to insure attachment of the first component to the second component, at least to the sum of thicknesses of the first and second components.

As discussed above, the inventive counter-screw means can provide an accessible from outside, attachment point, e.g., for a screw element, on a second component. In this case, the distance between the bearing and engagement sections of the counter-screw means corresponds at least to the thickness of the second component. The engagement section is inserted through the opening in the second component. Finally, the screw element, which is provided with the first threaded section is brought into engagement with the second threaded section provided on the counter-screw means. The screw element is actuated, and with the inventive counter-screw means, the attachment system is tightened.

As discussed above, the screw element that cooperate with the inventive counter-screw element, is formed, preferably, as a screw with an outer thread that forms a first threaded section and with a screw head an outer diameter of which is greater than the inner diameter of the through-opening in the bearing member, is used. On the screw head, there can be provided a band that increases the outer diameter of the head or a corresponding washer can be arranged.

The bearing section of the counter-screw means is formed preferably as a nut, with the second threaded section being formed by the nut inner thread. Alternatively, there can be provided, on the bearing section of the counter-screw means, a section with an outer thread serving as a second threaded section that would cooperate with a sleeve-shaped screw element having, at least regionwise, an inner thread functioning as a first threaded section.

Preferably, the distance between the connection section and the attachment axis amounts maximum to a triple of the diameter of the second threaded section. With such dimensions, the stresses that occur in the counter-screw means upon tightening of the attachment system, can be dealt with a small as possible thickness of the material used for producing the counter-screw means, and the counter-screw means can be cost-effectively manufactured. Advantageously, the distance between the connection section and the attachment axis is smaller than a diameter of the second threaded section, which results in optimization of the thickness of the counter-screw means and a most economical production of the counter-screw means. Generally, the entire outer dimensions of the counter-screw means can be very small, which permits to easily handle the attachment system even in a narrow space.

Preferably, at least one of the surfaces of the engagement section extend substantially parallel to one of the surfaces of the bearing member. Such counter-screw means can be simply introduced into the opening of the first and second components and be displaced therethrough. Alternatively or as a variant, a surface of the engagement section that contacts the support can form with a surface of the bearing member that contact the first component, an acute angle so that upon tightening of the attachment system, a certain spring action is provided between the counter-screw means and the second component. The presence of such spring action is particularly favorable when the attachment system is subjected to dynamic loads.

Advantageously, a guide sleeve is provided on the bearing section for the screw element. The guide sleeve guides the screw element such as a screw with an outer thread and a screw head, upon its displacement, which facilitates assembly of the attachment system. Advantageously, the second threaded section is formed in the guide sleeve. By increasing the thread length of the second threaded section, the counter-screw means can absorb large loads.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a perspective view of a support of a mounting system with a plurality components secured on the support with an attachment system according to the present invention;

FIG. 2 a perspective view of a first embodiment of the attachment system according to the present invention;

FIG. 3 a side exploded view of the attachment system shown in FIG. 2;

FIG. 4a-c a longitudinal cross-sectional view along line IV-IV in FIG. 1 through the attachment system shown in FIG. 2, illustrating three steps of mounting the attachment system;

FIG. 5 a cross sectional view along line V-V in FIG. 1;

FIG. 6 a side view of a second embodiment of the engagement member of the inventive attachment system; and

FIG. 7 a partial view of counter-screw means according to the present invention.

In the drawings the same elements are designated with the same reference numerals.

### DETAILED DESCRIPTION OF THE PREFERRED EMBODIMENTS

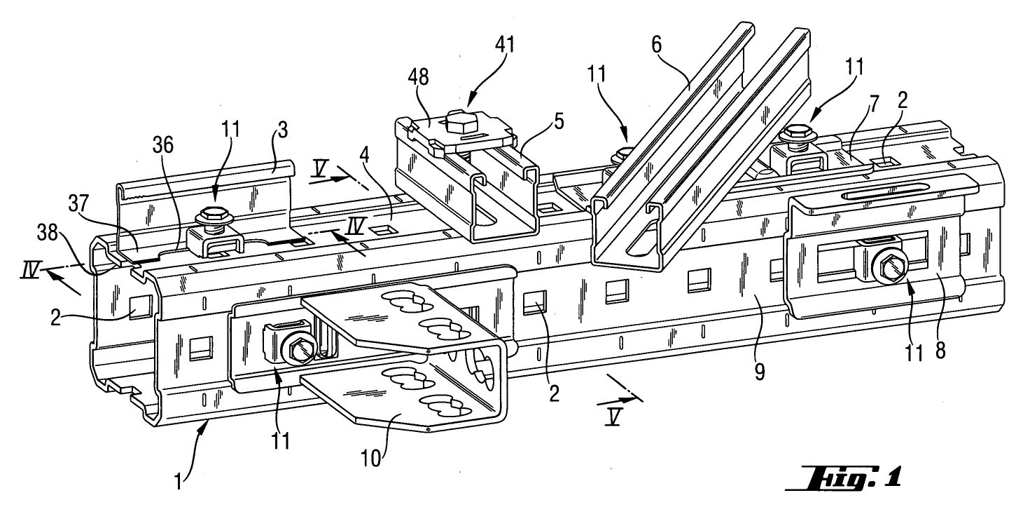

FIG. 1 shows a support 1 of a mounting system and having, in cross-section, a cross-section of a closed hollow body provided in outer walls thereof with a plurality of openings 2 spaced at a predetermined distance from each other. On the support 1 that forms a second component, a plurality of different first components are secured with an inventive attachment system 11 or 41.

Thus, e.g., a section 3 of a C-shaped mounting rail is secured in a recess 4, which is provided on the outer side of the support 1, with the inventive attachment system 11. A section of another C-shaped mounting rail 5 is secured with another inventive attachment system 41 on the outer side of the support 1 substantially perpendicular to a longitudinal axis of the recess 4. A C-shaped mounting rail 6, which is secured at an angle to the longitudinal axis of the recess 4, is secured on a mounting member 7 that is arranged in the recess 4 and is secured on the support 1 with two inventive attachment systems 11. An angle member 8 which is used, e.g., for attachment of an elbow pipe, is secured with the inventive system 11 in a recess 9 formed on another outerside of the support 1. Finally, as an example of a further component securable to the support 1 with the inventive attachment system 11, one may consider a connection element 10 for attaching another support or a mounting rail. The different first components described above do not limit the types of components that can be secured with the inventive attachment system 11 and/or 41 and different other components can be secured on the support 1 with the inventive attachment system 11 and/or 41.

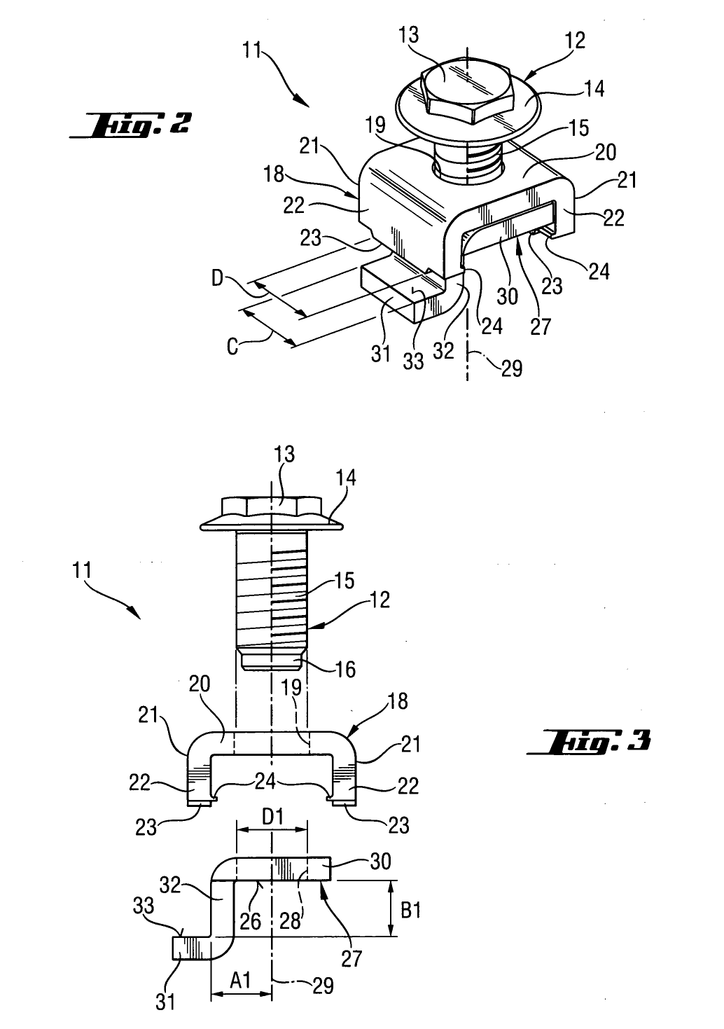

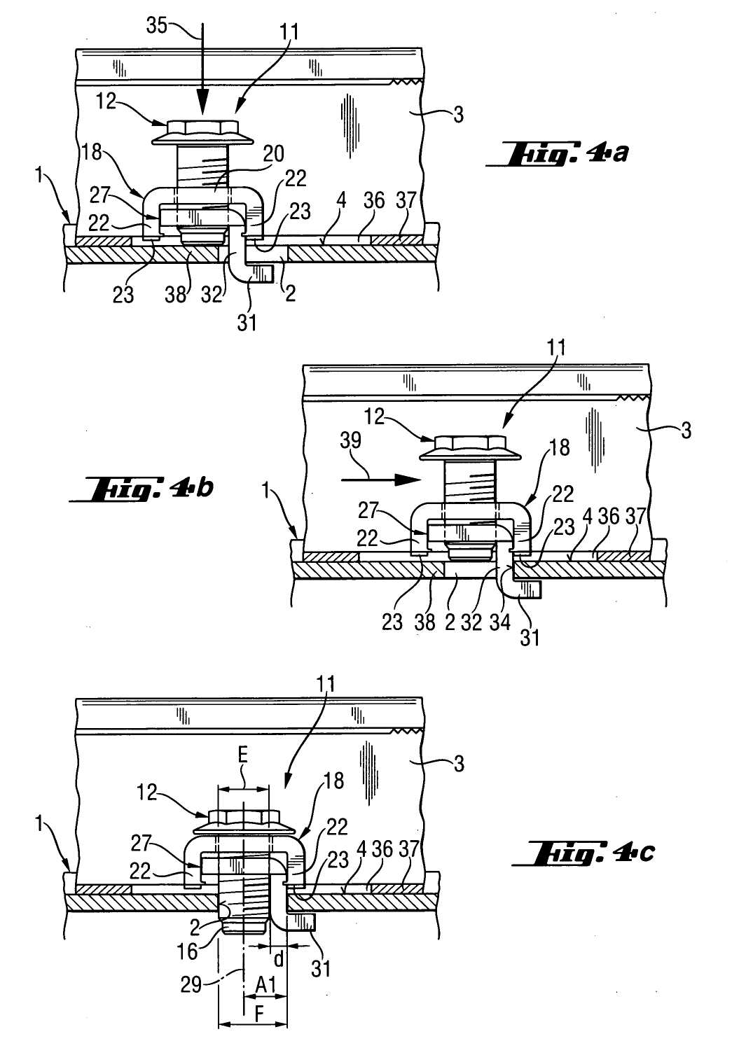

FIGS. 2 and 3 show a first embodiment of the inventive attachment system represented by the attachment system 11. The attachment system 11 includes a screw element 12 the hexagon screw head of which forms torgue transmitting means 13. For operating the screw element 12, a wrench, which engages the hexagon screw head, is used. On the hexagon screw head, there is provided a band 14. The screw element 12 further has a threaded section 15 with an outer thread.

The attachment system 11 further includes a bearing member 18 having a through-opening 19 through which the screw element 12 is extendable and which is formed in a plate-shaped part 20. At the opposite ends of the plate-shaped part 20, there are provided, respectively, two webs 22 having each a projection 23.

The webs 22, together with the plate-shaped part 20, form the bridge-shaped bearing member 18. On the webs 22, there are provided, respectively, two locking noses 24 aligned opposite each other.

The attachment system 11 further includes counter-screw means 27 having a threaded section 28 with an inner thread. The threaded section 28 defines an attachment axis 29 and cooperates with the threaded section 15 of the screw element 12. The counter-screw means 27 further includes an engagement section 31 and a bearing section 30. The engagement section 31 is spaced, in the direction of the attachment axis 29, from the bearing section 30 and is connected with the bearing section 30 by a connection section 32.

The outer surface 33 of the engagement section 31 of the counter-screw means 27 extends substantially parallel to the inner surface 26 of the bearing section 30 of the counter-screw means 27.

FIGS. 4a-4c illustrate an attachment process of the C-shaped mounting rail 3, which forms a first component, to the support 1 which forms a second component, with the inventive attachment system 11 which is formed of the screw element 12, the bearing member 18, and the counter-screw means 27 and which is available in form of an assembled device. The C-shaped mounting rail 3 is provided in its bottom 37 with a plurality of elongate openings 36. The C-shaped mounting rail 3 is so arranged in the recess 4 on the outer side of the support 1 that the elongate opening 36 in the bottom 37 of the C-shaped mounting rail 3 overlie an opening 2 in the surface of the support 1.

The attachment system 11 is displaced in the direction of arrow 35 for securing the two components so that the counter-screw means 27 is displaced through the elongate opening 36 in the C-shaped mounting rail 3 and the opening 2 in the support 1 and becomes arranged in the interior of the support 1. The distance B1 (see FIG. 3) between the engagement section 31 and the bearing section 30 of the counter-screw means 27 amounts at least to the sum of thicknesses of the wall 38 of the support 1 and the wall of the bottom 37 of the C-shaped mounting rail 3. The width C of the engagement section 31 is somewhat smaller than the inner dimension of the opening 2 in the wall 38 of the support 1.

The webs 22 of the bearing member 18 lie on the bottom 37 of the C-shaped mounting rail 3 and the projections 23, which are provided on webs 22, extend into the elongate opening 36 in the bottom 37 of the C-shaped mounting rail 3 and serve as a guide and for preventing rotation of the bearing member 18. The width D of the projections 23 is somewhat smaller than the inner width of the elongate opening 36.

Then, as shown in FIG. 4b, the attachment system 11 is pushed in the direction of the arrow 39 until the connection section 32 of the counter-screw means 27 abuts the wall 34 of the opening 2 in the wall 38 of the support 1. In this position of the bearing member 18, the engagement section 31 engages from beneath a region of the wall 38 of the support 1. The attachment system 11, upon being pushed into the elongate opening 36 in the bottom 37 of the C-shaped mounting rail 3 is guided by the projections 23 which are provided on the webs 22 of the bearing member 18.

Upon actuation of the screw element 12, the counter-screw means 27 are pulled toward the bearing member 18 which is supported on the bottom 37 of the C-shaped mounting rail 3. The engagement section 31 completely abuts the wall 38 of the support 1, and the attachment system 11 is tightened, whereby the C-shaped mounting rail 3 is releasably secured on the support 1.

The distance A1 between the connection section 32 of the counter-screw means 27 and the attachment section 29 is so selected that the sum of an outer diameter E of the threaded section 15 of the screw element 12 and the width of the connection section 32 corresponds approximately to the inner width F of the opening 2 in the support 1. The screw element 12 has, at its end remote from the torque transmitting means 13, a band 16 that facilitates the displacement of the screw element 12 in the opening 2 of the support 1. When the inner width F of the opening 2 in the support 1 is somewhat smaller than the sum of the outer diameter E: of the threaded section 15 of the screw element 12 and the thickness of the connection section 32, the attachment system 11 is secured to the support 1 upon screwing the screw element 12 in.

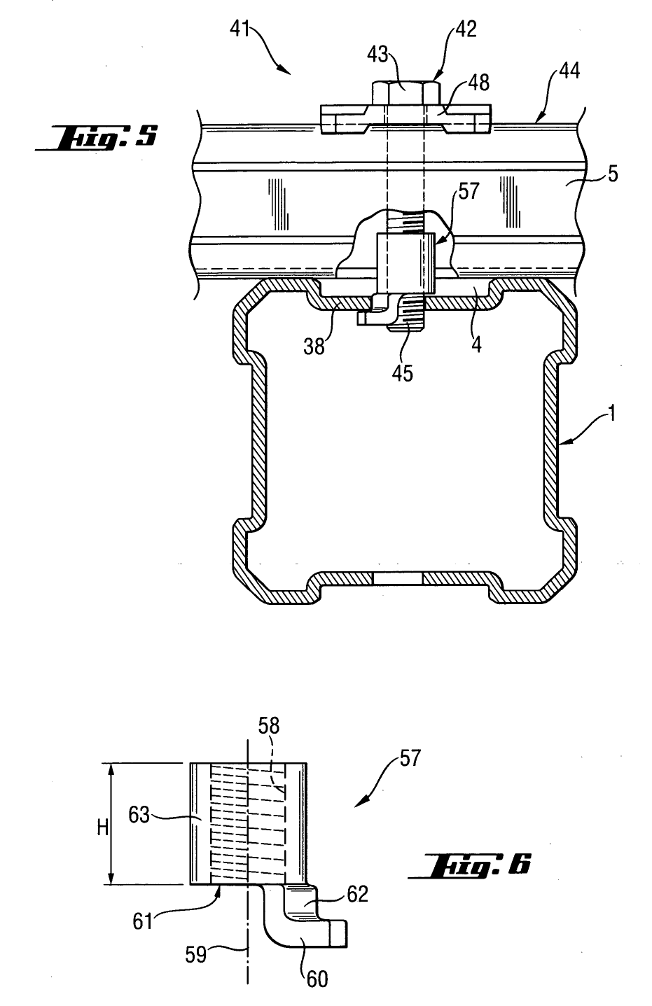

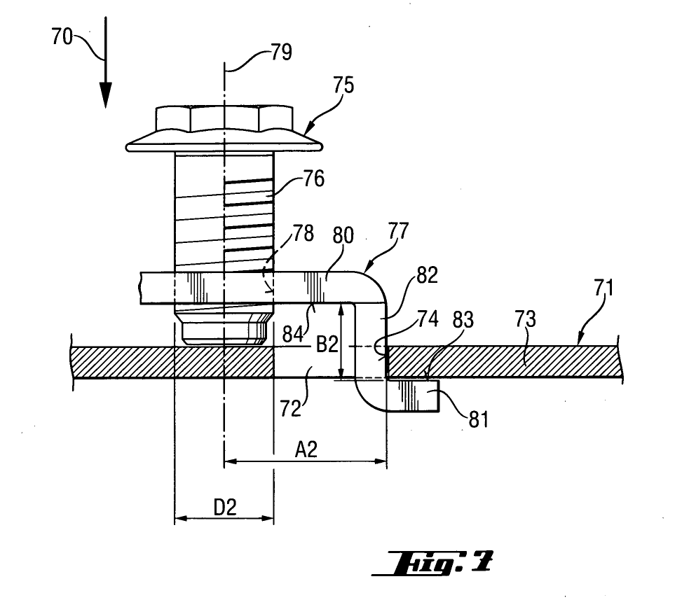

FIG. 5 shows a second embodiment of an attachment system 41 according to the present invention. The attachment system 41 includes a screw that forms a screw element 42 and has a screw head 43, which forms the torque transmitting means, and a threaded section 45 with an outer thread. The attachment system 41 further includes a plate-shaped, rectangular bearing member 48 that abuts an open side 44 of the C-shaped mounting rail 5 and counter-screw means 57. The counter-screw means 57, which is shown in FIG. 6, has a bearing section 61, an engagement section 60, and a connection section 62 that connects the engagement section 60 with the bearing section 61. On the bearing section 61, there is provided a guide sleeve 63 having a height H for the screw element 42. The guide sleeve 63 has a threaded section 58 with an inner thread an defines an attachment axis 59.

Both the counter-screw means 27 and the counter-screw means 57 can be used as an independent element for a conventional attachment system. A further embodiment of counter-screw means 77 is shown in FIG. 7. The counter-screw means 77 has a threaded section 78 with an inner thread and defines an attachment axis 79. The counter-screw means 77 further includes an engagement section 81 and a bearing section 80 which is spaced from the engagement section 81 in the direction of the attachment axis 79 and is connected with the engagement section 81 by a connection section 82.

The distance A2 between the connection section 82 and the attachment axis 79 approximately corresponds to double of the diameter D2 of the threaded section 78. The surface 83 of the engagement section 81 extends substantially parallel to the surface 84 of the bearing section 80.

The counter-screw means 77 are inserted in the opening 72 of the support 71 in the direction of arrow 70 so that the engagement section 81 is located in the interior of the support 71. The distance B2 between the engagement section 81 and the bearing section 80 amounts at least approximately to the thickness of the wall 73 of the support 71. The counter-screw means 77 is displaced until the connection section 82 of the counter-screw means 77 abuts the wall 74 of the opening 72 in the wall 73 of the support 71. The engagement section 81 engages a region of the wall 73. The screw element 75 with its threaded section 76 is brought in engagement with the screw section 78. Upon further advancement of the screw element 75, it becomes supported on the wall 73 of the support 71, and the bearing section 80 of the counter-screw means 77 is pulled in the direction opposite the direction of the arrow 70. With this, the engagement section 81 firmly abuts from behind the wall 73 and the counter-screw means 77 becomes firmly secured to the support 71.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. An attachment system for connecting a first component with a second component, comprising a screw element (12; 42) having torque transmitting means (13; 43) and, at least regionwise, a first threaded section (15; 45); a bearing member (18; 48) for abutting one of the components and having a through-opening (19) through which the screw element (12; 42) is extendable; and counter-screw means (27; 57; 77) defining an attachment axis (29; 59; 79) and having a second threaded section (28; 58; 78) cooperating with the first threaded section (15; 45) of the screw element (12; 42), an engagement section (31; 61; 81), a bearing section (30; 60; 80) spaced from the engagement section (31; 61; 81) in a direction of the attachment axis (29; 59; 79), and a connection section (32; 62; 82) for connecting the bearing section (30; 60; 80) with the engagement section (31; 61; 81).

2. An attachment system according to claim 1, wherein a distance (A1; A2) between the connection section (32; 82) and the attachment axis (29; 79) amounts maximum to a triple of a diameter (D1; D2) of the second threaded section (28; 78).

3. An attachment system according to claim 2, wherein the distance (A1; A2) between the connection section (32; 82) and the attachment axis (29; 79) is less than the diameter (D1; D2) of the second threaded section (28; 78).

4. An attachment system according to claim 1, wherein at least one of the surfaces (33; 83) of the engagement section (31; 61; 81) of the counter-screw means (27; 57; 77) extends parallel to at least one of the surfaces (26, 84) of the bearing section (30; 60; 80) of the counter-screw means (27; 57; 77).

5. An attachment system according to claim 1, wherein a guide sleeve (63) is arranged on the bearing section (60) of the counter-screw means (57).

6. An attachment system according to claim 5, wherein the second threaded section (58) is provided in the guide sleeve (63).

7. An attachment system according to claim 1, wherein the bearing section (48) is substantially plate-shaped.

8. An attachment system according to claim 1, wherein a bearing member (18) is provided on opposite longitudinal sides (21) thereof with webs (22)

9. An attachment system according to claim 8, wherein at least one projection is provided on each web (22).

10. An attachment system according to claim 8, wherein the webs (22) are provided with locking noses (23) for regionwise retaining the counter-screw means (27) on the bearing member (18) in a jointly displaceable condition of the bearing member (18) and the counter-screw means (27).

11. Counter-screw means for an attachment system for connecting a first component with second component and including a screw element (12; 42) having torque transmitting means (13; 43) and, at least regionwise, a first threaded section (15; 45); and a bearing member (18; 48) for abutting one of the components and having a through-opening (19) through which the screw element (12; 42) is extendable; the counter-screw means (27; 57; 77) defining an attachment axis (29; 59; 79) and comprising a second threaded section (28; 58; 78) cooperating with the first threaded section (15; 45) of the screw element (12; 42); an engagement section (31; 61; 81); a bearing section (30; 60; 80) spaced from the engagement section (31; 61; 81) in a direction of the attachment axis (29; 59; 79); and a connection section (32; 62; 82) for connecting the bearing section (30; 60; 80) with the engagement section (31; 61; 81).

12. Counter-screw means, according to claim 11, wherein a distance (A1; A2) between the connection section (32; 82) and the attachment axis (29; 79) amounts maximum to a triple of a diameter (D1; D2) of the second threaded section (28; 78).

13. Counter-screw means, according to claim 2, wherein the distance (A1; A2) between the connection section (32; 82) and the attachment axis (29; 79) is less than the diameter (D1; D2) of the second threaded section (28; 78).

14. Counter-screw means, according to claim 11, wherein at least one of the surfaces (33; 83) of the engagement section (31; 61; 81) of the counter-screw means (27; 57; 77) extends parallel to at least one of the surfaces (26, 84) of the bearing section (30; 60; 80) of the counter-screw means (27; 57; 77).

15. Counter-screw means, according to claim 11, wherein a guide sleeve (63) is arranged on the bearing section (60) of the counter-screw means (57).

16. Counter-screw means, according to claim 5, wherein the second threaded section (58) is provided in the guide sleeve (63).
